(19) United States
(12) Patent Application Publication
(10) Pub. No.: US 2004/0036475 A1
(43) Pub. Date: Feb. 26, 2004

(54) Battery monitoring

(76) Inventors: Phillip Enwood Pascoe, Christchurch (NZ); Phillip Mark Hunter, Christchurch (NZ); Adnan Al-Anbuky, Christchurch (NZ)

Correspondence Address: MYERS BIGEL SIBLEY & SAJOVEC, PO BOX 37428, RALEIGH, NC, 27627, US

(21) Appl. No.: 10/363,626

(22) PCT Filed: Sep. 4, 2001
(86) PCT No.: PCT/NZ01/00183

(30) Foreign Application Priority Data
Sep. 4, 2000 (NZ) 506707

(51) Int. Cl. G01N 27/42; G01N 27/416

(52) U.S. Cl. 324/425; 324/429; 324/427

(57) ABSTRACT

An architecture for organising information in a battery monitoring system, the architecture having a hierarchy of levels including a first level containing information relating to battery variables; a second level containing information relating to analysis of real-time or trend behaviour of the battery variables, and a third level containing user information relating to user and/or maintenance parameters, the user information being derived from the first and/or second level information. A method of estimating the condition of one or more cells, the method including periodically measuring the capacity of the cells, wherein the type of measurement and/or the period between measurements is dependent upon the state of health of the cell or cells and/or the result of a previous test.

The invention relates to a method and apparatus for monitoring the condition of one or more cells of a battery and an architecture for organising information in a battery monitoring system. The invention is particularly suited to monitoring valve regulated lead acid (VRLA) batteries.

Early battery monitoring systems were basic data loggers. Analysis of logged data related to trend behaviour and inter-bloc comparison. The user or operator was required to interpret this data to determine the state of the installation. Events and alarm messages were generated as the behaviour was viewed or automatically generated. However, these alarms only identified maintenance issues once the problem had progressed to a certain stage.

More sophisticated monitoring systems have used block impedance to derive information relating to the block state-of-charge and capacity. Even though the depth of monitoring involvement has substantially improved, existing systems still produce substantial redundancies in the information presented. This results in an increased burden and the possibility of confusion for the system user or operator rather than providing guidance in resolving operational and maintenance issues relating to the battery installation.

Current practice in monitoring systems is to either provide continuous on-line monitoring or intermittent monitoring. With intermittent monitoring, the battery condition is tested periodically. The duration between tests could be as long as one year, particularly for remote installations. While the results of such tests should provide sufficient information to establish battery condition, there is the possibility that battery failure may occur in the elapsed time between tests. Additionally, where information is being used to establish trend behaviour there is a requirement to maintain consistency in performing the tests. This is especially difficult if there is a change in operator and/or test equipment.

Some of the problems associated with periodic testing are overcome by continuous on-line monitoring. With continuous on-line monitoring, the equipment is permanently connected to the battery and would normally provide information relating to the base-line battery parameters (e.g. voltage and current). Some more sophisticated monitors provide estimation of charge, impedance and/or capacity as part of their short or long-term trend analysis. The continued problem is that most existing systems expose all of this detailed information to the operator who is then required to perform intensive analysis to determine any operational and maintenance issues.

Accordingly, it is an object of the present invention to provide a battery monitoring system which provides efficient and informative information relating to battery health, and when corrective action is required. Another object or the present invention is to maximise the confidence in real-time measurement and trend analysis of battery information.

It is a further object of the present invention to provide a battery monitoring system which overcomes or ameliorates some of the disadvantages with prior art systems or which at least provides industry with a useful alternative.

In a first aspect the invention provides an architecture for organising information in a battery monitoring system, the architecture having a hierarchy of levels including a first level containing information relating to real-time battery variables; a second level containing information relating to analysis or trend behaviour of the real-time battery variables; and a third level containing user information relating to user and/or maintenance parameters, the user information being derived from the first and/or second level information.

In a second aspect the invention provides a battery monitoring system including storage means containing information arranged in the architecture of the first aspect of the invention.

In a third aspect the invention provides a method of presenting battery information using the architecture or system of the first or second aspect of the invention, the method comprising acquiring real-time battery variables from a battery; storing the real-time battery variables as first level information in the first level; processing the real-time battery variables to generate the second level information; storing the second level information in the second level; processing the stored first and/or second level information to derive the user information; storing the user information in the third level; and presenting the stored user information to a user.

Preferably the first level includes real-time information relating to voltage and/or current and/or temperature, the second level includes information relating to charge-discharge cycles and/or thermal accumulation and/or capacity and/or charge accumulation, and the third level includes information relating to remaining life and/or reserve time.

Preferably a user or operator is only exposed to information in the third level.

Typically the second and/or third level information is derived from two or more different battery variables. For instance, in one example Reserve Charge (second level information) is derived from current, voltage and temperature variables (ie three different battery real-time variables).

Typically the second level contains information relating to two or more second level parameters, and the second and/or or third level information is derived from two or more of the stored second level parameters. For instance in a preferred example the second level contains information relating to three second level parameters: Charge Accumulation; Dis/Charge Cycles and Thermal Accumulation. These three parameters are used to calculate a fourth second level parameter: State of Health. A fifth second level parameter (Capacity) is then determined by performing a discharge test. Remaining Life (third level information) is then estimated by analysing a series of Capacity figures.

The storage means may be a single storage device, or may be distributed in two or more separate storage devices, coupled by a fixed or wireless link.

Typically the system including one or more sensors for acquiring the information relating to battery variables.

Typically means for presenting the user information to a user is provided, such as a display device.

According to a fourth aspect the invention provides a method of estimating the condition of one or more cells, the method including periodically measuring the capacity of the cells, wherein the type of measurement and/or the period between measurements is dependent upon the state of health of the cell or cells and/or the result of a previous test.

According to a fifth aspect the invention provides a device for estimating the condition of one or more cells, the device including means for periodically measuring the capacity of the cells, and means for varying the type of measurement and/or the period between measurements dependent upon the state of health of the cell or cells and/or the result of a previous test.

The fourth/fifth aspects of the invention provide a method/device for adaptively adjusting the type of measurement or measurement period, thus enabling more accurate and useful measurements to be made.

Typically the method includes performing two or more discharge tests which each discharge the cell or cells by a different amount which is dependent upon the state of health of the cell or cells and/or the result of a previous test.

In a preferred case the method includes performing at least three discharge tests which each discharge the cell or cells by a respective different amount which is dependent upon the state of health of the cell or cells and/or the result of a previous test.

The invention thus envisages that preferably, although not exclusively, the type of measurement may be one of a full discharge capacity test or a medium discharge capacity test or a short discharge capacity test, the test performed in any one period being dependent on the state of health of the cell(s), the state of health being a function of one or more parameters which effect the useful life of the cell(s).

Preferably the parameters which effect the useful life of the cell(s) are one or more of charge-discharge cycles and/or thermal accumulation and/or capacity and/or charge accumulation.

The fourth aspect of the invention may include a method of utilising continuous on-line measurement of one or more parameters relating to one or more cells to establish a real-time assessment of the state or health of the cell(s), wherein the monitoring system automatically adapts respondent to changes in cell health.

In a preferred example the method includes performing a plurality of short discharge tests which each discharge the cell or cells by a relatively small discharge amount, and performing a plurality of long discharge tests between the relatively short discharge tests which each discharge the cell or cells by a relatively large discharge amount.

Typically the period between the long discharge tests is greater than the period between the short discharge tests. This enables the relatively long discharge tests to be performed relatively infrequently, resulting in less disruption of battery operation.

Typically the long and/or short discharge tests each discharge the cell or cells by substantially the same discharge amount.

Typically the period between measurements (preferably between the relatively long discharge tests) decreases over time. This enables the end of battery life to be determined more accurately.

Typically the method includes measuring a parameter of one or more of the cells to establish the state of health of the cell or cells.

The method may including estimating the remaining life of the cell or cells from the measured capacity of the cell or cells. This provides useful information which can then be presented to a user, preferably by a method according to the third aspect of the invention.

Further aspects of the invention will become apparent from the following description which is given to illustrate the invention, and with reference to the accompanying drawings in which:

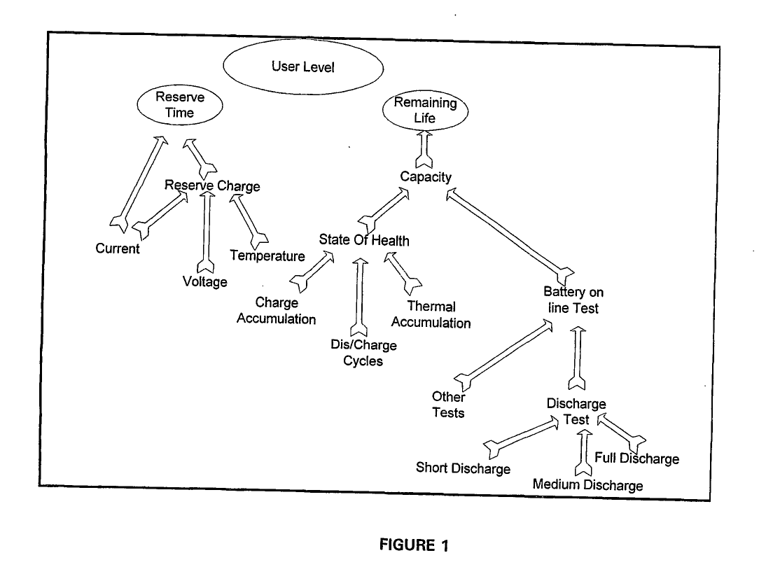

FIG. 1: illustrates a hierarchy of cell monitoring information;

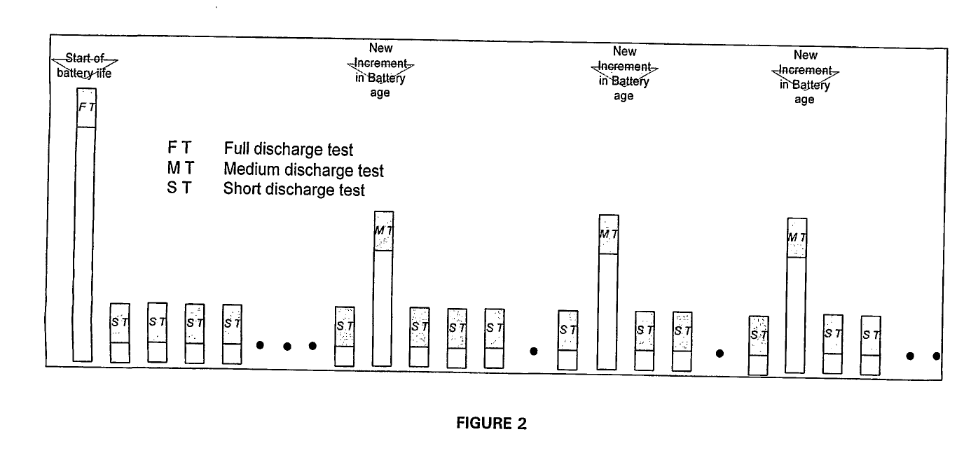

FIG. 2: illustrates a scenario for an adaptive and compound battery test schedule according to the invention;

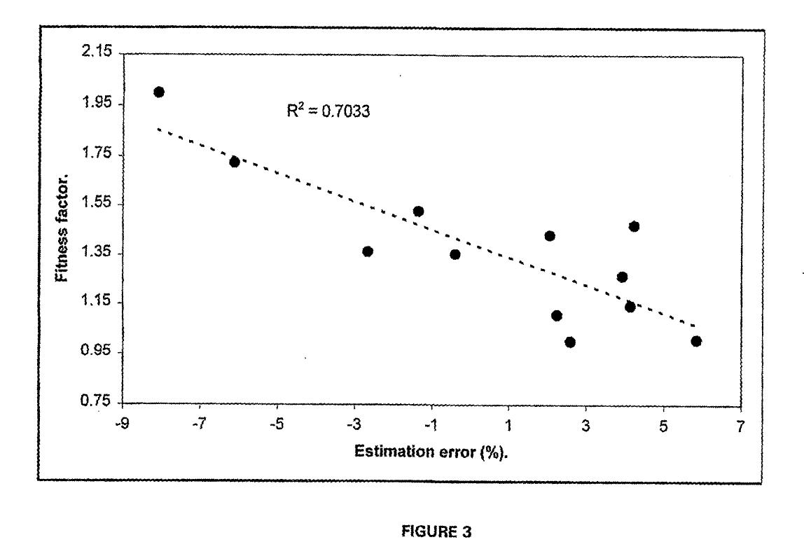

FIG. 3: shows a scatter diagram of estimation verses fitness factor after a 30% discharge;

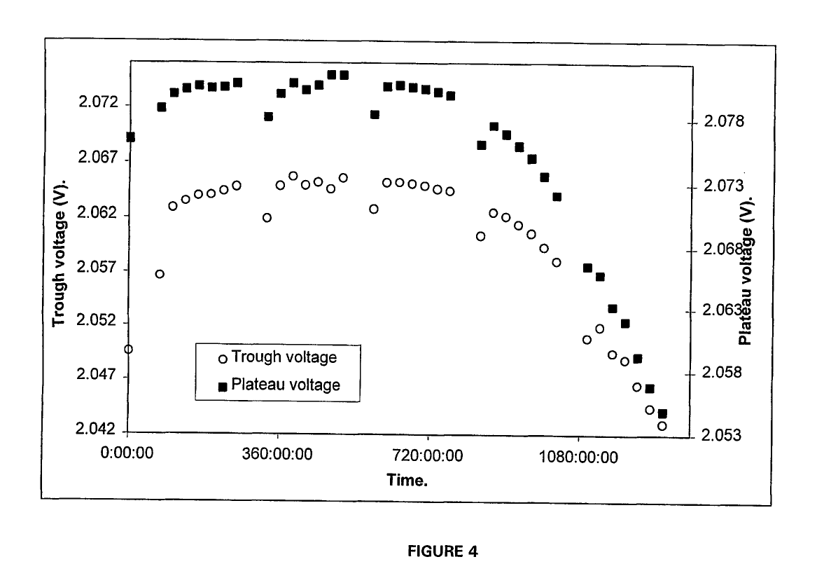

FIG. 4: illustrates a Coup De Fouet test utilised for capacity trend estimation; and

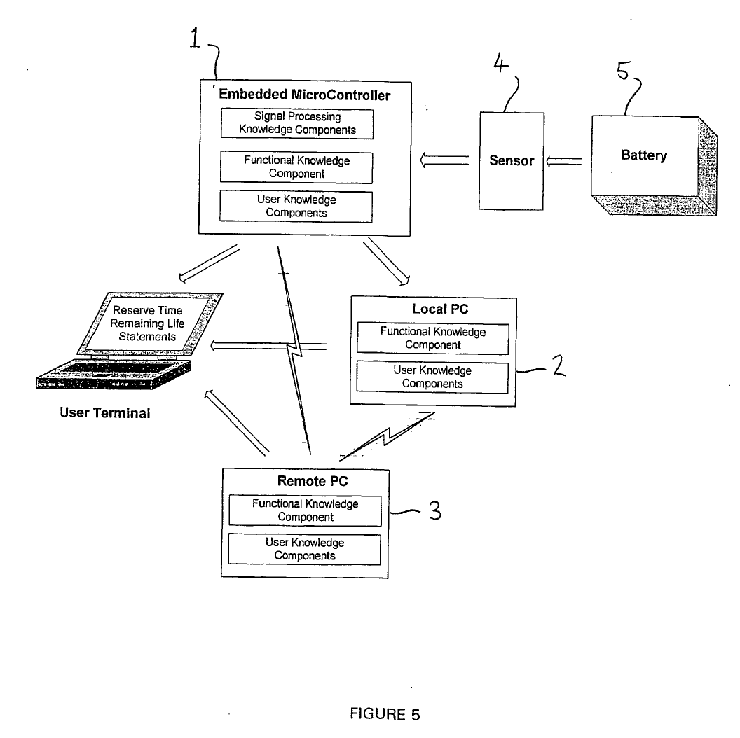

FIG. 5: illustrates a preferred battery monitoring system for performing the invention.

In order to work the invention, battery data and information is divided into different levels of involvement as related to a battery monitoring system. These levels might be thought of as the Signal Level, the Functional Level, and the Maintenance Level.

The Signal Level reflects the real-time and trend behaviour of the battery variables. These variables are the voltage, current and temperature of the battery. This data, together with its trend analysis, can provide an indication of battery status. Information obtained from these variables may also highlight events relevant to battery health.

The battery Functional Level reflects more compound information that is based on the analysis of real-time and trend behaviour of the battery variables. It relates to information such as charge-discharge cycles, thermal accumulation, capacity, and charge accumulation, The information in this level may be used to highlight significant operational conditions that may have an effect on battery health. An example might be the battery being exposed to thermal stress for a significant period. Another example might be charge-discharge cycle information—both the count and the depth are required to assess the amount of influence this has on battery health.

The most significant information to the user is that which is provided at the Maintenance Level. This information is the Reserve Time and the Remaining Life of the battery. These parameters are normally derived from information obtained in the Functional or Signal Levels. For example, Remaining Life may be readily obtained from information relating to battery capacity, and Reserve Time can be obtained from state-of-charge and real-time discharge current information. The information hierarchy relating Signal and Functional Level information to Maintenance Level information is illustrated in FIG. 1.

In a preferred embodiment of the invention it is envisaged that Signal Level information is monitored in real-time by a computerised monitoring system. The monitoring system automatically trends the information in real-time to provide information relating to the Functional Level, for example charge accumulation, charge-discharge cycles and thermal accumulation. This information can be used to directly estimate battery state-of-charge and also to establish an adaptive testing scenario for estimating battery capacity, and hence Remaining Life. These are described in greater detail below. This embodiment allows full automation of the monitoring regime with the user only being exposed to Maintenance Level information including user information, and the rest of the information being hidden from the user. Alarm schedules based on Signal and Functional level boundaries may also be included. Alarm implementation is discussed below.

Battery Reserve Time (or battery Remaining Time) is a key user requirement during discharge. This provides real time update of information on the discharge time remaining (in hours and/or minutes and/or seconds) until a targeted end voltage is reached during battery discharge. It helps the user plan for efficient utilisation of the remaining discharge time before the standby power runs out. This parameter can be readily obtained from the present value of battery load current (discharge current) and battery state-of-charge. A number of techniques have been used to estimate state-of-charge. One particularly useful technique is obtaining a state-of-charge estimation utilising real-time battery voltage readings during discharge. This method is described in the Applicant's earlier patent application published as WO 00/13288, the contents of which are considered to be included as if individually set forth herein.

This method produces a single voltage/state-of-charge profile which represents the battery characterisation. The characterisation may stay with the battery over its entire operating life. However, during any discharge, either a regular test or an operational discharge, the degree of compliance of the characterisation with the actual behaviour of the battery can be determined to highlight the need for re-characterisation. This compliance test is conducted using a fitness factor which is calculated during any discharge opportunity.

The fitness factor can be determined in a number of ways. Typically, when undertaking a discharge estimated results are compared with actual results obtained over, say, the first 30% of the discharge and the difference used to determine a fitness factor. The difference is best expressed as a unit or percentage value. If the actual and estimated values were the same then the fitness factor would be 1 (or 100%) and there would be no need to recharacterise the battery. However, if the fitness factor changed by plus or minus, say, 0.05 (or 5%) then a recharacterisation would occur. For example, when a medium discharge test (described later) is taking place the actual amp-hours (AH) dissipated over the discharge is tested against the estimated amp-hours (AH) for the same change in voltage. If they are equal then the fitness factor is 1, otherwise the result will be an over fitness or under fitness. When the deviation in fitness exceeds a certain configurable limit recharacterisation of the voltage/state-of-charge characteristic is needed.

FIG. 3 shows a typical estimation error verses fitness factor scatter diagram obtained from a medium—30%—discharge of a string of 12 Oldham 2HI275 cells. It illustrates that the cells with the worst/lowest fitness factor have the worst charge remaining estimation.

Battery capacity is an important parameter which leads to the estimation of battery age and hence the other key use requirement—battery Remaining Life. Conventionally the battery life remaining is considered as an indication of the number of years and/or months and/or day remaining for the battery before it reaches 80% of its nominal capacity. Generally there is a slow increase in battery capacity in the early stage of life. The capacity then settles at a steady level for most of its life until it starts declining rapidly reflecting the end of battery life. The 80% level of battery designed capacity has typically been used as the criteria for determining the end of life. The estimation of the end of battery life improves as the capacity starts to decline. The significance of this is that towards the end of battery life the requirement for capacity testing increases as does the frequency of testing. This means that as more samples of capacity accumulate over the battery life, the capacity and hence end of battery life can be determined with greater confidence. Employing a strategy according to the invention enables the number of capacity samples to be increased and hence an improved estimation of remaining operational life is obtained.

There are a number of measurement techniques which may be used to establish capacity. However, there are three techniques which are most suited to the current invention. These techniques may be thought of as the Full capacity test, the Medium capacity test, and the Short capacity test.

The Full capacity test provides the greatest confidence through the use of a full discharge test. This test is conducted according to IEEE STD 1188-1996, “IEEE Recommended Practices for Maintenance, Testing and Replacement of Valve Regulated Lead Acid (VRLA) Batteries in Stationary Applications.” Although this test provides the greatest confidence it is undesirable as it leaves the system vulnerable to failure or requires the use of an auxiliary power supply. In addition, it also has the requirement of discharge loads and constant supervision. Therefore, it is only recommended to use this test during commissioning of a battery installation.

The Medium capacity test overcomes the problem of the full discharge by providing a method of estimating capacity using a partial discharge to a depth of between, say, 30% and 50% of depth with analytical extrapolation of battery behaviour outside this range. Such a test is suggested by T. Yamashita, M. Murase, K. Sekiya, and S. Ishibe in “A New Battery Check System in Telecommunications Power Plants,” NTT Review, Vol. 9, No. 3, May 1997.

A Short capacity test derives an estimation of the capacity from information relating to the Coup De Fouet region of an initial battery discharge. This estimation only requires a short discharge test of between, say, 2% and 10% in depth. This test is the subject of the Applicant's earlier patent application number published as WO 00/75678. It is also described by P. E. Pascoe and A. H. Anbuky in “Estimation of VRLA Battery Capacity Using the Analysis of the Coup de Fouet Region” INTELEC, 1999; and, “VRLA Battery Capacity Estimation using Soft Computing Analysis of Coup de Fouet Region” INTELECT, 2000. The Short capacity test reduces the consumption of battery life through testing, and allows for higher frequency of testing. In addition, it leaves the power system less vulnerable in the event of a mains or equipment failure during testing.

FIG. 2 illustrates an adaptive monitoring regime according to one embodiment of the invention. The embodiment illustrated uses an adaptive combination of the full, medium and short capacity tests described above. The tests are represented in FIG. 2 by FT, MT and ST respectively and are performed periodically. The horizontal axis of FIG. 2 represents time.

Combinations of the above tests performed in a determined periodic manner provides a good trade-off between the involvement and security of the testing regime and the degree of confidence in the information gathered about the battery while not adversely degrading battery life as a result of an aggressive test regime. This information can then be used to provide the user with an indication of Remaining Life of the battery. State-of-charge information can also be indicated when a discharge occurs. This is updated in a real time manner over the discharge duration and until the end voltage is reached. At the same time the Reserve Time is derived from the state of charge and battery discharge rate. Validity of the state of charge algorithm fitness against actual battery behaviour is also tested. As a result a fitness factor is derived. The fitness factor can be utilised during the full or medium tests to highlight the need to re-establish the voltage/state-of-charge characterisation.

The adaptability of the test is based on establishing a compound state of health indicator which allows an incremental age of the battery to be established. A full discharge test is conducted first at commissioning to provide a reference point. Regular short discharge tests are then conducted. The duration between short discharge tests could be as short as one week. Because of the nature of the short discharge test they can be performed regularly with minimal degradation of battery life. FIG. 4 shows the Coup De Fouet trough and plateau voltages from periodic short discharges test, and illustrates the gradual reduction in capacity of a battery as it ages.

At every checkpoint as defined by the health indicator, a medium discharge test is conducted. This will provide a more rigorous estimation of capacity and is used as a periodic check on the accuracy of the capacity—and subsequently battery remaining life—estimated from short discharge tests. In addition it will provide both training for the short discharge as well as the identification of possible divergence in battery characterisation. The actual duration between medium discharge tests is adaptive according to the degree and form of stress the battery is being exposed to.

The health indicator is composed of other indicators such as:

a) Charge-discharge cycles: batteries are normally designed to deliver a certain number of charge discharge cycles over there entire operating life. Manufacturers normally specify a table that relates the discharge depth to the number of available cycles.

b) Accumulative thermal stress: temperature higher than the battery base temperature has a detrimental effect on battery life. This has been approximated as a halving of the operational life for every 10° C. rise in temperature above the battery base temperature. A battery at 10° C. above the nominal temperature will age at twice the normal rate.

c) Charge Accumulation: The float voltage will affect the polarisation of the individual plates within a cell. The positive plate should be maintained at a polarisation that will produce minimal corrosion of the positive grid. Literature reflects a rise in corrosion both above and below the ideal plate polarisation. Insufficient polarisation of either plate can also result in the gradual discharging of that plate or the cell.

d) Operation duration: Battery operational time measured in hours, days, weeks, months and/or years reflecting the duration from the last thorough capacity test (checkpoint).

The incremental change in battery age may be estimated using the compound effect of the above attributes. This could be expressed by the following formula:

Incremental Age=ƒ (operational duration, Float age, Cycle Age)

Where;

Float Age=ƒ (Block Temperature, Float Voltage)

Cycle Age=ƒ (Depth of discharge, No of discharges)

This formula reflects a fuzzy neuro/learning network relationship that may be adapted using the behaviour of the battery. An Adaptive Neural Fuzzy Inference System (ANFIS) might be employed. Such systems are discussed by J. -S. R. Jang, C. -T. Sun, and E. Mizutani in “Neuro-Fuzzy and Soft Computing, A Computational Approach to Learning and Machine Intelligence”, Prentice Hall, New Jersey, USA, 1997; and J. S. R Jang, “ANFIS: Adaptive-Network-Based Fuzzy Inference System,” IEEE Trans. Syst., Man Cybern., Vol. 23, pp. 665-685, 1993. The fuzzy logic Matlab™ toolbox supports this technique.

The frequency of the medium discharge test can be specified in terms of age increments which define checkpoints. For example an incremental age of two years will expose a battery designed for a 20-year age to ten checkpoints. If the health indicator shows that the battery is being subjected to operating conditions such that the battery would only last a quarter of its designed life, say 5 years, the checkpoints or incremental age is automatically adjusted likewise—i.e. instead of repeating the medium test at 2 years it is repeated at 6 months. Thus, these checkpoints form the baseline for triggering a medium capacity test. The medium test should provide an update to the battery condition and derive a realistic estimate of the Remaining Life. The use of the incremental age (which indicates the duration required before a new medium discharge test is needed), and state of health indicator (which related to the extent of utilisation of the battery during the last duration from last medium test)to determine the time between test means that as the battery ages—either normally or prematurely due to adverse operating conditions—the number of tests is increased thus improving the estimation of capacity and remaining life. In addition they can be used to assess the significance of the particular operating conditions on battery life and hence adapt the relationship defined in the incremental age equation.

The above testing regime can be implemented in a computerised monitoring system with no, or minimal, intervention from operators or maintenance staff. Staff are provided with indication of state of charge and/or time remaining and battery remaining life. Where an interface between the monitoring system and other systems—such as battery charger—can be provided, the monitoring system can issue instructions to take preventative action in response to conditions affecting battery state of health, for example float voltage and temperature. The system can also implement an alarm strategy which only immediately alerts operators or maintenance staff on urgent or critical conditions. Other non-urgent events are hidden from average operators. They should be analysed by an involved operator or smart software for operational recommendations.

An alarm is categorised as an event that raises the need for an action by the user or the system to reduce or avoid any impact on system performance. Here, the size of involvement will be related to the degree of automation available within the system. A degree of information hiding should be implemented in order to avoid unnecessary details that might be a source of confusion to the human user. For example, if proper charge management is implemented there will be no need for alarming on need for bloc equalise (standard charging practice for unifying the charge state of all cells within a battery) as it is going to happen automatically.

A reasonable level of automation will also eliminate the need for the operator to interpret the base variable—voltage, current and temperature—behaviour. These are hidden within the system implementation. Important features may be recorded for future analysis. The system will use them to provide recommendations or for imposing control. Furthermore, functional related alarms should be employed for driving tests that reveal more precise information on the battery condition. They may also be used for providing appropriate control recommendations. These types of alarms should be categorised as important events. They are outside the average user domain. Alarms should be related to blocs, strings or the entire battery approaching the end of charge or end of life. In this case the alarm level should be made relative to the role associated to the source of the alarm and reflect the alarm objectives. For example, if the alarm is to provide warnings related to system integrity, then the following is suitable:

a) Bloc fail is considered as a non-urgent alarm

b) String fail is considered as a urgent alarm

c) Battery fail is considered as a catastrophic alarm

A bloc fail takes place when one of the blocs within a string fails. This could either be charge failure (bloc voltage fall below the prespecified end voltage) or capacity failure (bloc capacity falls below 80% nominal capacity). In a similar way string and battery failure could be related to the string end voltage and string capacity for the string and battery end voltage and battery capacity for the battery. While the battery level presents the full contribution of battery to the load, the string level presents partial contribution. In the same sense the bloc level presents even smaller contribution that could not be noticeable by the load.

Thus the alarm level is related to the size of impact the situation could have on the system integrity. Each alarm level provides information on an action to be taken.

Another type of alarm is that related to actions required for preventive maintenance. These are considered as part of the events that are taken care of by the system. This is based on the assumption that the battery management system has sufficient automation to cater for taking the necessary real-time corrective action. Examples are the action needed to relieve the system from overcharging, undercharging or thermal stress. If however, the system is not capable of handling the actions, then monitoring should provide necessary guidance to the operator for imposing the corrective action related to the event. Examples of common events that highlight the need for preventive maintenance are:

a) Thermal Stress as a result of persistence of high temperature.

b) Lack of charge which could be a result of the end of discharge, or charge leakage

c) Voltage dive at the early stage of discharge

d) High number of charge—discharge cycles

e) Persistent high float voltage

These types of events may be related to bloc, string or battery. The system should be able to use absolute base variables, relative values among a group and in reference to a given limit or average, and trend analysis for inferring the event.

These types of events hold various degrees of confidence in the message they may deliver. They are categorised as potential identifiers of the need for a more thorough investigation on a certain health issue. The bloc voltage behaviour on float or charging for example may reveal bloc weakness. A persistent high level on float may reflect a weakness in capacity. The duration for persistence should exceed that related to the overcharging transient in order to remove the conflict. Low level on float may reflect charge weakness. This should be eliminated after an equalise charge.

Hardware for implementation of knowledge based battery monitoring is within the know-how of the skilled addressee and may be implemented in a known manner. The main issue related to implementing the battery monitoring and health assessment algorithms described above is voltage, temperature and current measurement. In particular, the ability to acquire accurate and timely voltage measurements is critical. The accuracy and resolution of the voltage measurement directly impacts on the accuracy and resolution of the derived information. This is especially important for capacity estimation utilising the Coup De Fouet region. For thorough implementation (down to bloc level), hardware is required that can monitor the voltage of each bloc at the start of discharge at a frequency of up to 1 Hz.

There are additional advantages in utilising distributed hardware. Management of the battery data may take place either at the bank level, battery level or even the bloc node level. This distribution of knowledge as related to their locality could provide an optimised solution.

An example of suitable hardware for performing the invention is shown in FIG. 5. The system comprises a sensor (for sensing the battery voltage, current and temperature), software (for implementing the functional and organisational algorithms), processing means (for running the software) and a user terminal incorporating display means for presenting the relevant information.

In the example of FIG. 5, the processing means is implemented in a distributed network including an embedded microcontroller 1, local PC 2 and remote PC 3. In an alternative system, the processing means may be more centralised.

The embedded microcontroller, local PC and remote PC each include associated memory devices for storing the Signal Processing Components, Functional Knowledge Components and User Knowledge Components, as shown explicitly in FIG. 5.

The sensor 4 samples the battery voltage at regular intervals that are significant to the captured information. Sensing accuracy and resolution will be dependent on the particular application.

The software simulates the organisational and processing algorithm in deriving the various functional information from the sensed voltage, current and temperature readings.

The embedded micro-controller 1 acquires the information on each of the three variables from the sensor 4.

Sensed real time data is processed by the embedded micro-controller. Further processing for extracting the functional and operational information could be implemented on the embedded micro-controller 1, local PC 2 or remote PC 3.

Distribution of processing components (knowledge elements) could be based on computational complexity and real time criticality. For example the reserve time estimation requires monitoring of real time voltage readings at intervals of seconds or minutes. Therefore this estimation process may be performed by the local embedded microcontroller. On the other hand, capacity estimation requires monitoring of partial or full discharges at intervals of from a few weeks to a few months. The discharges may take a few minutes or a few hours. Therefore capacity estimation can be performed by the local or remote PCs.

Communication with the PCs could take place over a variety of communication means that could either be based on standard or proprietary protocols. This could be based on using wired or wireless communication means.

The battery 5 could be a single cell, a group of cells or mono-blocs, a string of cells or a multiple string battery.

The embedded microcontroller deals with the real time acquisition and signal processing. The embedded microcontroller is normally resident close to the process (i.e. the battery). The voltage, temperature and current are the main variables considered here.

Thus the invention provides a knowledge based battery monitoring and test regime which utilises on-line continuous measurements, including planned tests and unplanned events, for the assessment of real-time battery health. Both direct health dependent parameters such as charge and capacity, and indirect operational parameters such as voltage, temperature and discharge rate are taken into consideration. The analysis is based on capacity, which dominates the interpretation of battery state of health.

The functional level is related to the knowledge components that are recognisable by the user and could contribute in formulating the user level. Examples of these types of knowledge elements are reserve charge, capacity, state of health, . . . etc.

The user (or maintenance) level is related to the knowledge components that are relevant key to the user and formulate the objective targets. Examples of these are reserve time and remaining life.

Each of the knowledge components represents the algorithm or the object that generate the relevant information for that particular function. For example the charge accumulation, Dis/charge cycles and thermal accumulation information will formulate the state of health information. This in turn will indicate if a capacity test is needed or not. It will also highlight the relevance of the type of test to be conducted.

The knowledge component organisation allows for encapsulating the details of battery behavioural features within a relational structure that exposes the relevant details related to the user and hides the unnecessary details.

Where in the foregoing description reference has been made to elements or integers having known equivalents, then such equivalents are included as though individually set forth.

Although the invention has been described by way of example and with reference to particular embodiments, it is understood that modifications and/or improvements can be made without departing from the scope thereof.

1. An architecture for organising information in a battery monitoring system, the architecture having a hierarchy of levels including a first level containing information relating to real-time battery variables; a second level containing information relating to analysis or trend behaviour of the real-time battery variables; and a third level containing user information relating to user and/or maintenance parameters, the user information being derived from the first and/or second level information.

2. The architecture of claim 1 wherein the first level contains information relating to voltage and/or current and/or temperature.

3. The architecture of claim 1 or 2 wherein the second level contains information relating to charge-discharge cycles and/or thermal accumulation and/or reserve charge and/or capacity and/or charge accumulation.

4. The architecture of any of the preceding claims wherein the third level contains information relating to remaining life and/or reserve time.

5. The architecture of any of the preceding claims wherein the second and/or third level information is derived from two or more different battery variables.

6. The architecture of any of the preceding claims wherein the second level contains information relating to two or more second level parameters, and wherein the second and/or third level information is derived from two or more of the stored second level parameters.

7. A battery monitoring system including storage means containing information arranged in the architecture of any one of the preceding claims.

8. The system of claim 7 wherein the storage means includes two or more separate storage devices.

9. The system of claim 8 wherein the separate storage devices are coupled by a wireless link.

10. The system of claim 7, 8 or 9 including one or more sensors for acquiring the information relating to battery variables.

11. The system of any of claims 7 to 10 including means for presenting the user information to a user.

12. A method of presenting battery information using the architecture or system of any of the preceding claims, the method comprising acquiring real-time battery variables from a battery; storing the battery variables as first level information in the first level; processing the real-time battery variables to generate the second level information; storing the second level information in the second level; processing the stored first and/or second level information to derive the user information; storing the user information in the third level; and presenting the stored user information to a user.

13. The method of claim 12 including presenting only the stored user information to the user.

14. The method of claim 12 or 13 wherein the second and/or third level information is derived from two or more different battery variables.

15. The method of any of claims 12 to 14 wherein the second level contains information relating to two or more second level parameters, and wherein the third level information is derived from two or more of the stored second level parameters.

16. A method of estimating the condition of one or more cells, the method including periodically measuring the capacity of the cells, wherein the type of measurement and/or the period between measurements is dependent upon the state of health of the cell or cells and/or the result of a previous test.

17. The method of claim 16 including performing two or more discharge tests which each discharge the cell or cells by a different amount which is dependent upon the state of health of the cell or cells and/or the result of a previous test.

18. The method of claim 17 including performing at least three discharge tests which each discharge the cell or cells by a respective different amount which is dependent upon the state of health of the cell or cells and/or the result of a previous test.

19. The method of claim 17 or 18 including performing a plurality of short discharge tests which each discharge the cell or cells by a relatively small discharge amount, and performing a plurality of long discharge tests between the relatively short discharge tests which each discharge the cell or cells by a relatively large discharge amount.

20. The method of claim 19 wherein the period between the long discharge tests is greater than the period between the short discharge tests.

21. The method of claim 19 or 20 wherein the short discharge tests each discharge the cell or cells by substantially the same discharge amount.

22. The method of claim 19, 20 or 21 wherein the long discharge tests each discharge the cell or cells by substantially the same discharge amount.

23. The method of any of claims 16 to 22 wherein the period between measurements decreases over time.

24. The method of claims 19 and 23 and wherein the period between the relatively long discharge tests decreases over time.

25. The method of any of claims 16 to 24 including measuring a parameter of one or more of the cells to establish the state of health of the cell or cells.

26. The method of any of claims 16 to 25 including estimating the remaining life of the cell or cells from the measured capacity of the cell or cells.

27. The method of claim 12 including the steps of estimating the condition of one or more cells by the method of any of claims 16 to 26; storing the capacity measurements in the second level; performing a trend analysis on the capacity measurements to calculate a remaining life parameter; storing the remaining life parameter in the third level; and presenting the remaining life parameter to a user.

28. The method of any of claims 12 to 27 wherein the battery is a valve regulated lead acid (VRLA) battery.

29. A device for estimating the condition of one or more cells, the device including means for periodically measuring the capacity of the cells, and means for varying the type of measurement and/or the period between measurements dependent upon the state of health of the cell or cells and/or the result of a previous test.

30. The device of claim 29 adapted to perform the method of any of claims 16 to 27.
